(19) United States
(12) Patent Application Publication
(10) Pub. No.: US 2011/0295710 A1
(43) Pub. Date: Dec. 1, 2011

(54) BUSINESS DEVELOPMENT TOOL AND TOM$CORE SCORING MODEL

(76) Inventors: Craig Charak, Elk Grove, IL (US); Thomas Meyer, Hawthorn Woods, IL (US); Paul V. Miller, Hawthorn Woods, IL (US)

(21) Appl. No.: 13/149,691

(22) Filed: May 31, 2011

Related U.S. Application Data
(60) Provisional application No. 61/349,623, filed on May 28, 2010.

(51) Int. Cl. G06Q 30/00

(52) U.S. Cl. 705/26.2

(57) ABSTRACT

Embodiments of the invention relate to a system, method, computer product and computer system for selling a business. The method forms a set of qualified buyers and a set of qualified sellers; enabling only the set of qualified buyers to view at least one business offered for sale by the set of qualified sellers. The method further enables the set of qualified buyers and the set of qualified sellers to upload documents necessary to fund and close the sale of the at least one business; and provides the set of qualified buyers and the set of qualified sellers access to trusted support professionals.

### CLAIM FOR PRIORITY

This application is related to, and claims priority from, U.S. Provisional Application No. 61/349,623 filed May 28, 2010 titled “Business Development Tool” the complete subject matter of which is incorporated herein by reference in its entity.

### FIELD OF THE INVENTION

The invention relates to a system, method, computer product and computer system for selling businesses. More particularly, embodiments relate to a system, method, computer product and computer system for matching buyers and sellers qualified to buy and sell a business.

### BACKGROUND OF THE INVENTION

An estimated $10 trillion of baby boomer-owned U.S. small businesses will need to provide an exit event for their owners over the next decade as boomers retire. These events may be in the form of shutting down, selling to a family member, selling to management, initiating a partner buy-out, selling to a competitor, selling to a private equity firm, or selling to outside individuals. Most business owners are looking for a qualified buyer, and herein lies the problem—there is currently no simple and reliable way to find prospective buyers. A similar challenge faces serious business buyers. A simple process for finding and qualifying businesses for sale does not exist today.

In addition to the future $10 trillion of business requiring owner exits over the next decade, there are approximately 50,000 businesses for sale advertised online at any given time. The number of qualified business buyers is more difficult to ascertain, particularly as buyer counts on existing sites have not participated in a reputable qualification process. Management estimates there are probably between 50,000 and 200,000 qualified business buyers in the United States. This is probably a conservative assumption, as the Center for Venture Research determined that there were more than 250,000 active angel investors in 2009. Additionally, industry statistics provide enlightening insights that each supports the need for a more effective process for bringing qualified business buyers and sellers together, and helping them consummate successful transactions. 90% of everyone who starts looking to buy a business never does. Only 20% of all businesses listed for sale actually sell. Only 10% of all deals involve business brokers. And lastly, 50% of all deals fall apart after a letter of intent, during due diligence. These platform and qualification solution can significantly improve these statistics for all involved in the industry.

While there are many business brokers and websites that promote businesses for sale, there is no uniform and streamlined system for matching qualified buyers and sellers. For the foregoing reasons, there is a need for a uniform and streamlined system for matching qualified buyers and sellers.

As a result, it would be desirable to provide a talent acquisition system that is capable of identifying talent on the basis of an existing candidate profile, in addition to a position profile.

### SUMMARY OF THE INVENTION

Embodiments of the invention relate to a system, method, computer product and computer system for selling a business. The method forms a set of qualified buyers and a set of qualified sellers; enabling only the set of qualified buyers to view at least one business offered for sale by the set of qualified sellers. The method further enables the set of qualified buyers and the set of qualified sellers to upload documents necessary to fund and close the sale of the at least one business; and provides the set of qualified buyers and the set of qualified sellers access to trusted support professionals.

Another embodiment relates to a system for computer moderated selling of a business, the system including a matching engine and a server. The matching engine is configured to forming a set of qualified buyers and a set of qualified sellers. The server has computer instructions enabling only the set of qualified buyers to view businesses offered for sale by the qualified sellers; enabling the set of qualified buyers and the set of qualified sellers to upload documents necessary to fund and close the sale of the at least one business; and provide the set of qualified buyers and the set of qualified sellers access to trusted support professionals.

Yet another embodiment relates to a computer program including a computer readable medium having computer readable instructions for selling a business. The computer readable instructions are configured to form a set of qualified buyers and a set of qualified sellers; enabling only the set of qualified buyers to view at least one business offered for sale by the set of qualified sellers. The computer readable instructions are further configured to enable the set of qualified buyers and the set of qualified sellers to upload documents necessary to fund and close the sale of the at least one business; and provide the set of qualified buyers and the set of qualified sellers access to trusted support professionals.

One embodiment relates to a method for enabling selling a business, the method comprising determining a qualifying score for a plurality of sellers based on subjective and objective criteria and determining a qualifying score for a plurality of buyers based on subjective and objective criteria. The method matches a plurality of buyers with at least one seller based on a derived overall score comprised of the qualifying score of the plurality of buyers and the qualifying score of the plurality of sellers forming a set of qualified buyers and a set of qualified sellers. The method further enables only the set of qualified buyers to view businesses offered for sale by the qualified sellers; enables the set of qualified buyers and the set of qualified sellers to upload documents necessary to fund and close the sale of the business; and provides the set of qualified buyers and the set of qualified sellers access to trusted support professionals.

Another embodiment relates to a system for computer moderated selling of a business comprising determining a qualifying score for a plurality of sellers based on subjective and objective criteria and determining a qualifying score for a plurality of buyers based on subjective and objective criteria. The system matches a plurality of buyers with at least one seller based on a derived overall score comprised of the qualifying score of the plurality of buyers and the qualifying score of the plurality of sellers forming a set of qualified buyers and a set of qualified sellers. The system further enables only the set of qualified buyers to view businesses offered for sale by the qualified sellers; enables the set of qualified buyers and the set of qualified sellers to upload documents necessary to fund and close the sale of the business; and provides the set of qualified buyers and the set of qualified sellers access to trusted support professionals.

Still another embodiment relates to a computer program product comprising a computer readable medium having computer readable instructions for selling a business, the computer readable instructions configured to determine a qualifying score for a plurality of sellers based on subjective and objective criteria and determine a qualifying score for a plurality of buyers based on subjective and objective criteria. A plurality of buyers are matched with at least one seller based on a derived overall score comprised of the qualifying score of the plurality of buyers and the qualifying score of the plurality of sellers forming a set of qualified buyers and a set of qualified sellers. The instructions enable only the set of qualified buyers to view businesses offered for sale by the qualified sellers; enable the set of qualified buyers and the set of qualified sellers to upload documents necessary to fund and close the sale of the business; and provide the set of qualified buyers and the set of qualified sellers access to trusted support professionals and qualified strategic partners to help them bring the deal to the finish.

Yet another embodiment relates to a computer system comprising a business matching engine; a plurality of sellers accessing the business matching engine using a communications network coupled to the business matching engine; and a plurality of buyers accessing the business matching engine using a communications network coupled to the business matching engine. The business matching engine has computer readable instructions for selling a business, the computer readable instructions configured to determine a qualifying score for a plurality of sellers based on subjective and objective criteria and determine a qualifying score for a plurality of buyers based on subjective and objective criteria. The instructions match a plurality of buyers with at least one seller based on a derived overall score comprised of the qualifying score of the plurality of buyers and the qualifying score of the plurality of sellers forming a set of qualified buyers and a set of qualified sellers; enable only the set of qualified buyers to view businesses offered for sale by the qualified sellers; and enable the set of qualified buyers and the set of qualified sellers to upload documents necessary to fund and close the sale of the business; and provide the set of qualified buyers and the set of qualified sellers access to trusted support professionals.

Yet another embodiment relates to a method for enabling a financial transaction, the method comprising determining a qualifying score for a plurality of first users based on subjective and objective criteria and a qualifying score for a plurality of second users based on subjective and objective criteria. The method further includes matching a plurality of second users with at least one first user based on a derived overall score comprised of the qualifying score of the plurality of second users and the qualifying score of the plurality of first users, forming a set of qualified second users and a set of qualified first users; enabling only the set of qualified second users to view businesses offered for sale by the qualified first users. Additionally the method comprises enabling the set of qualified second users and the set of qualified first users to upload documents necessary to fund and close the sale of the business; and providing the set of qualified second users and the set of qualified first user's access to trusted support professionals.

Still another embodiment relates to a system for computer moderated financial transactions, the system comprising a matching engine and a server. The matching engine is configured to determine a qualifying score for a plurality of first users based on subjective and objective criteria; determine a qualifying score for a plurality of second users based on subjective and objective criteria; and match a plurality of second users with at least one first user based on a derived overall score comprised of the qualifying score of the plurality of second users and the qualifying score of the plurality of first users forming a set of qualified second users and a set of qualified first users. The server enables only the set of qualified second users to view businesses offered for sale by the qualified first users; enabling the set of qualified second users and the set of qualified first users to upload documents necessary to fund and close the sale of the business; and provides the set of qualified second users and the set of qualified first users access to trusted support professionals.

Yet one more embodiment relates to a computer program product comprising a computer readable medium having computer readable instructions for financial exchange, the computer readable instructions configured to determine a qualifying score for a plurality of first users based on subjective and objective criteria and a qualifying score for a plurality of second users based on subjective and objective criteria. Instructions further include matching a plurality of second users with at least one first user based on a derived overall score comprised of the qualifying score of the plurality of second users and the qualifying score of the plurality of first users forming a set of qualified second users and a set of qualified first users; enabling only the set of qualified second users to view businesses offered for sale by the qualified first users; enabling the set of qualified second users and the set of qualified first users to upload documents necessary to fund and close the sale of the business; and providing the set of qualified second users and the set of qualified first users access to trusted support professionals.

Yet still another embodiment relates to a computer system comprising a financial exchange matching engine; a plurality of first users accessing the financial exchange matching engine using a communications network coupled to the financial exchange matching engine and a plurality of second users accessing the financial exchange matching engine using a communications network coupled to the financial exchange matching engine. The business matching engine has computer readable instructions for conducting financial exchanges configured to determine a qualifying score for a plurality of first users based on subjective and objective criteria and a qualifying score for a plurality of second users based on subjective and objective criteria. Instructions further include matching a plurality of second users with at least one first user based on a derived overall score comprised of the qualifying score of the plurality of second users and the qualifying score of the plurality of first users forming a set of qualified second users and a set of qualified first users; enabling only the set of qualified second users to view businesses offered for sale by the qualified first users; enabling the set of qualified second users and the set of qualified first users to upload documents necessary to fund and close the sale of the business; and providing the set of qualified second users and the set of qualified first users access to trusted support professionals.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 depicts a schematic representation of a computer system in accordance with one embodiment of the present invention;

FIG. 2 depicts a schematic representation of the system, computer program produce and computer system in accordance with one embodiment of the present invention;

FIG. 3 depicts a high level flow chart illustrating the method in accordance with one embodiment;

FIG. 4A-4D depict the buyer registration screens in accordance with one embodiment;

FIG. 5A-5E depict the seller registration screens in accordance with one embodiment;

Throughout the various figures, like reference numbers refer to like elements.

### DETAILED DESCRIPTION OF PRESENTLY PREFERRED EMBODIMENTS

While there are many business brokers and websites that promote businesses for sale, there is no uniform and streamlined system for matching qualified buyers and sellers. Embodiments of the present invention overcomes these prevalent challenges, bringing qualified business buyers and sellers together, along with all the professional services and strategic partners necessary to consummate a successful transaction. The target market is anyone interested, motivated, and qualified to buy or sell a small business. The present invention provides a powerful arena where serious buyers and sellers will be able to meet, match, and close deals.

To achieve this objective, embodiments use a highly reputable qualification regimen similar to those used in the banking industry, to prequalify business buyers, and to value businesses for sale, thereby legitimizing both sides of a deal. The regime evaluates objective and subjective variables in order to derive an overall point score that is used to make qualification determinations. This process enables business buyers and sellers to save both time and money. It also eliminates unqualified buyers, and those that are not currently serious about buying a business. Using embodiments of the invention, buyers will only be shown businesses they are prequalified for. Both buyers and sellers will be able to access qualified strategic partners who can help with virtually any aspect of the business sale process. Embodiments are similar to existing services in that it lists small to medium-sized businesses for sale. However, it differs significantly by being the first online platform with a prequalifying component to connect sellers with appropriate buyers from the start.

Today, all leading business-for-sale websites are essentially just online classifieds, and are primarily advertising supported. In contrast, the present invention adds real value and efficiency to the buying and selling process. Embodiments of the invention takes price as an obstacle out of the equation, allowing serious sellers to meet serious qualified buyers. Embodiments of the invention enable buyers and sellers to connect with each other anonymously, and ask questions to determine if the other side is serious before meeting. Buyers and sellers can also upload all documents necessary to close and fund a deal, providing access to trusted support professionals. The end result is that for serious business buyers and sellers, embodiments of the invention can help reduce the average time it takes to find, qualify, and close a transaction from about 2 years down to less than 6 months.

It is contemplated that revenue may be generated from pre-qualifying buyers, valuing businesses for sale, enabling business brokers to list businesses for sale for a monthly fee, and qualified buyer matching. All of these fees are paid before services are rendered. Additionally, buyers and sellers can subscribe to a membership in the site, which will provide access to insider information and useful tools that help prepare for all aspects of the transaction. The last major revenue source is pre-qualifying strategic partners who are rigorously screened and pay a fee to become certified strategic partners. Services will be marketed to small and medium-sized business sellers and buyers. Benefit-rich information and multimedia utilities on the website will attract the more serious buyers and sellers to subscribe for a modest monthly fee. These subscribers will receive regular industry updates, invitations to participate in useful programs and discussions, along with promotions featuring solutions and testimonials of full-program clients. A trial program will be used to briefly allow subscribers to experience the benefits of getting qualified and participating in the qualified matching program.

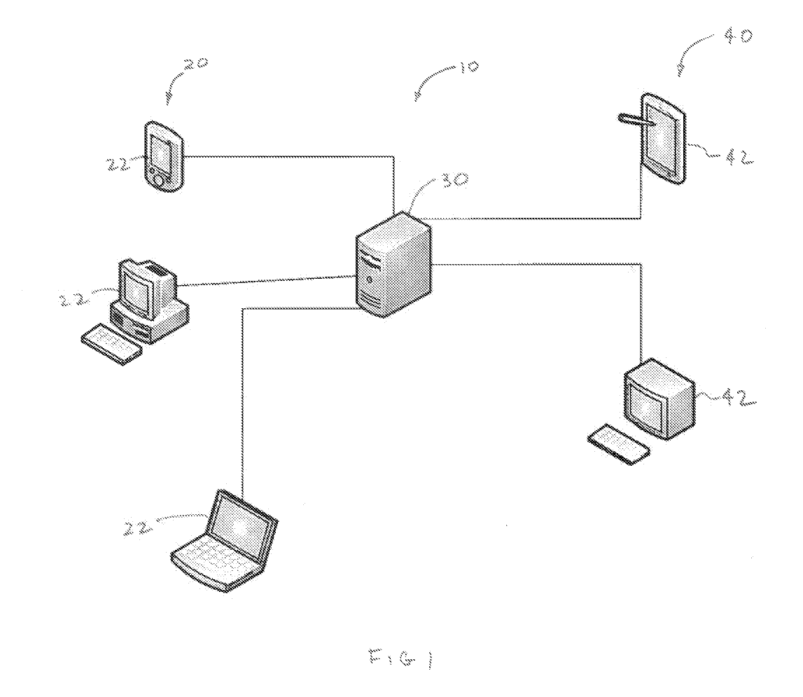

FIG. 1 provides a schematic representation of a computer system including instructions generally designated 10, for selling a business in accordance with one embodiment. FIG. 1 illustrates a buy side 20 and a sell side 40 communicating with a server 30 via any hardwired or wireless communication network. FIG. 1 depicts the buy side 20 includes a plurality of buyers communicating with the server 30 using one or more user interface devices 22 including PCs, laptops, tablets, cell phones, and PDAs, among other devices. Sell side 30 further includes a plurality of sellers communicating with the server 30 using one or more user interface devices 42 including PCs, laptops, tablets, cell phones, and PDAs, among other devices. In at least one embodiment, the server 30 includes memory and databases for storing instructions and data, the data comprising a set of programs and a dataset having one or more data fields; and processing devices executing the instructions and processing the data necessary to operate at least the buy side qualification and filtering engine, the sell side qualification and filtering engine and/or the matching engine as provided below.

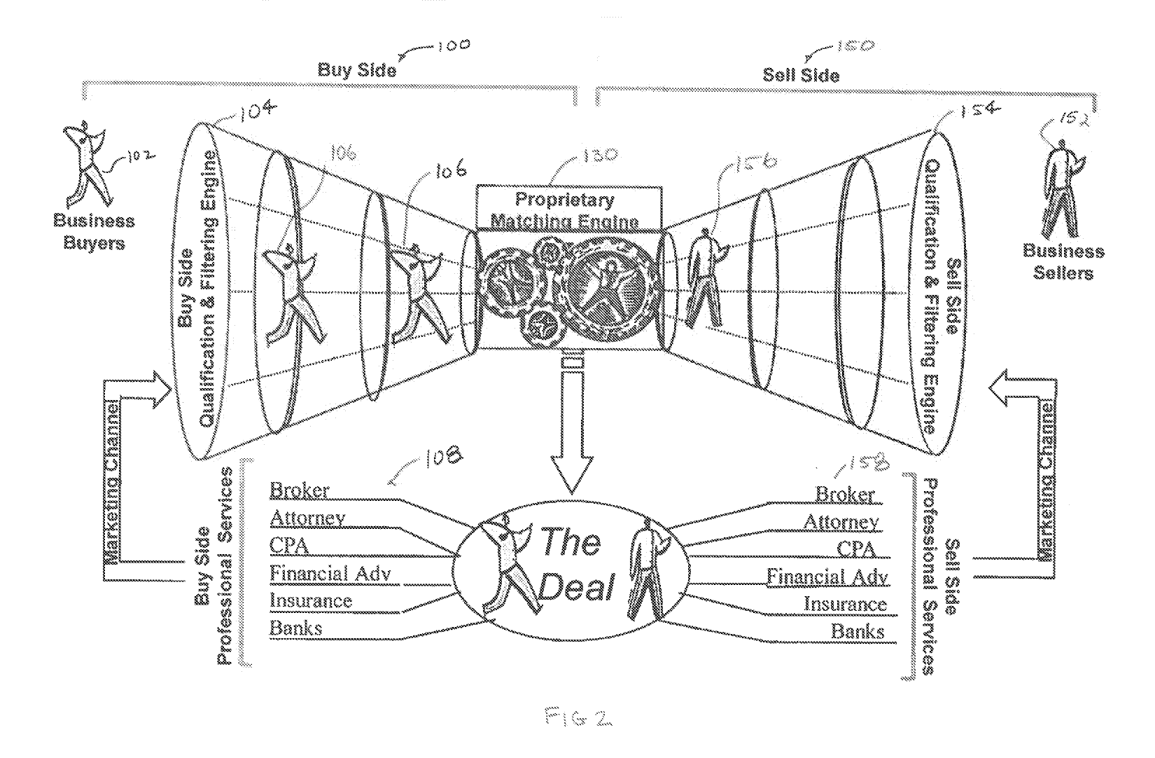

FIG. 2 provides a schematic representation of a system, computer program product and computer system for selling a business in accordance with one embodiment. FIG. 2 illustrates a buy side 100 comprised of one or more buyers 102 and a sell side 150 comprised of one or more sellers 152. The buy side 100 includes a buy side qualification and filtering engine 104 that determines a qualifying score for the plurality of buyers 102 based on subjective and objective criteria and a sell side qualification and filtering engine 154 that determines a qualifying score for a plurality of sellers 152 based on subjective and objective criteria. In at least one embodiment, the buyers 102 communicate with the buy side qualification and filtering engine 104 using a hardwired or wireless communication network and any user interface device including PCs, cell phones, PDAs as illustrated previously, among other devices, while the sellers 152 communicate with the sell side qualification and filtering engine 154 using a communication network using similar user interface devices including PCs, cell phones, PDAs as illustrated previously, among other devices as is well known in the art.

FIG. 2 further illustrates both the buy side qualification and filtering engine 104 and the sell side qualification and filtering engine 154 operatively coupled to and communicating with a matching engine 130. The matching engine 130 matches a plurality of buyers 102 with at least one seller 152 based on a derived overall score comprised of the qualifying score of the plurality of buyers 102 and the qualifying score of the plurality of sellers 152 forming a set of qualified buyers 106 and a set of qualified sellers 156. Embodiments further enable only the set of qualified buyers 106 to view businesses offered for sale by the qualified sellers 156.

Embodiments of the invention further enable the set of qualified buyers 106 and the set of qualified sellers 156 to upload documents necessary to fund and close the sale of the business. Additionally, embodiments provide the set of qualified buyers 106 and the set of qualified sellers 156 access to trusted support professionals 108/158 comprising one or more of Brokers, Attorneys, CPAs, Financial Advisors, Banks, etc.

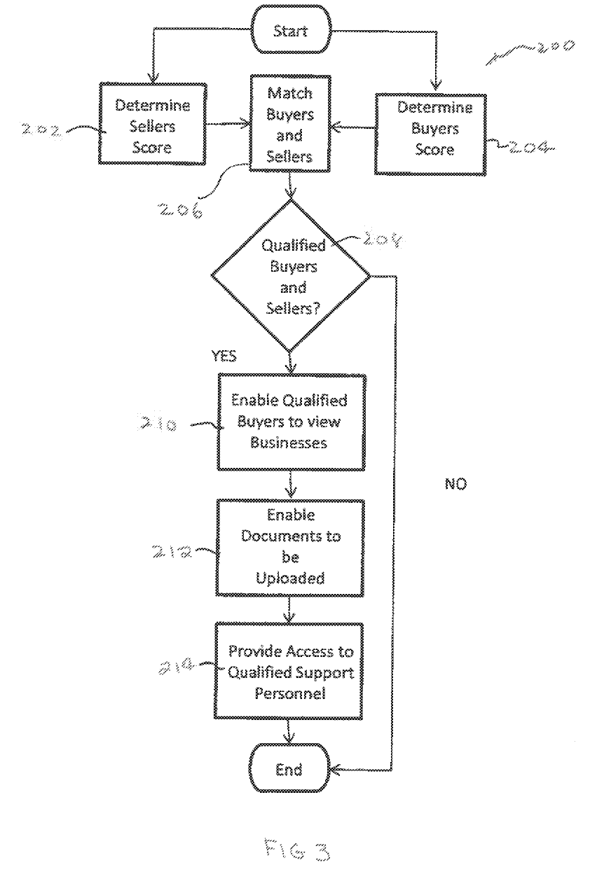

FIG. 3 illustrates a method 200 for enabling selling a business. In this embodiment, the method 200 comprises determining a qualifying score for one or more sellers, block 202, based on one or more subjective and objective criteria and determining a qualifying score for one or more buyers, block 204, based on one or more subjective and objective criteria. The method 200 matches a plurality of buyers with at least one seller, block 206, based on a derived overall score comprised of the qualifying score of the plurality of buyers and the qualifying score of the plurality of sellers forming a set of qualified buyers and a set of qualified sellers, block 208. The method 200 further enables only the set of qualified buyers to view businesses offered for sale by the qualified sellers, block 210; enables the set of qualified buyers and the set of qualified sellers to upload documents necessary to fund and close the sale of the business, block 212; and provides the set of qualified buyers and the set of qualified sellers access to trusted support professionals, block 214.

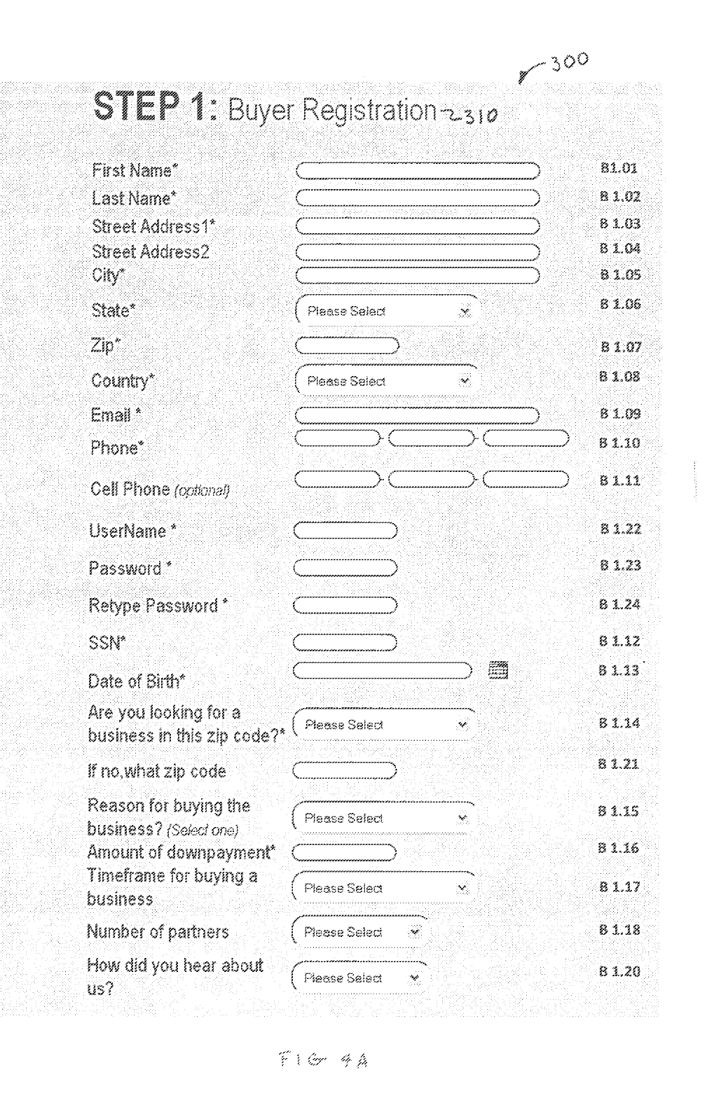

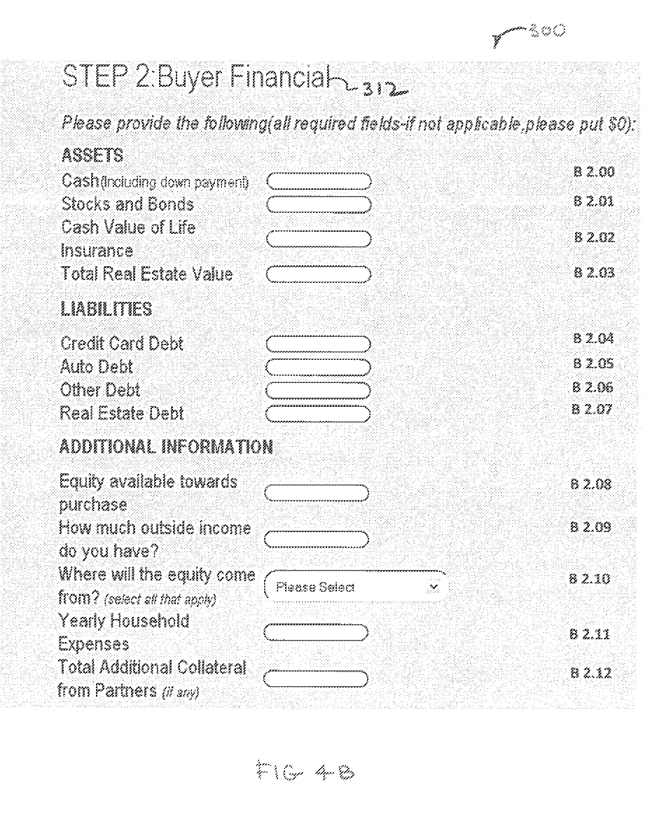

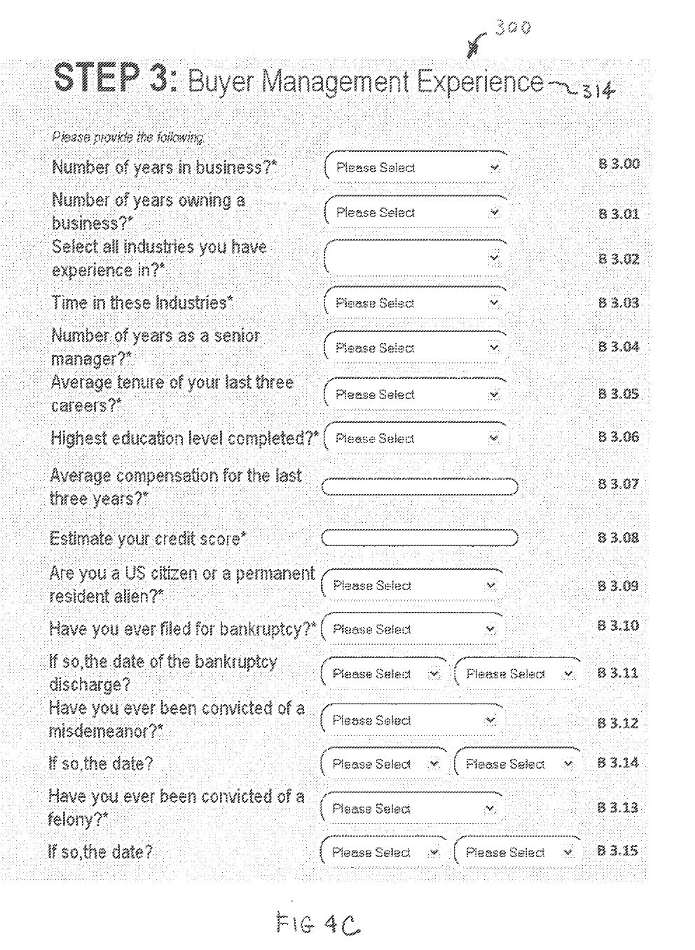

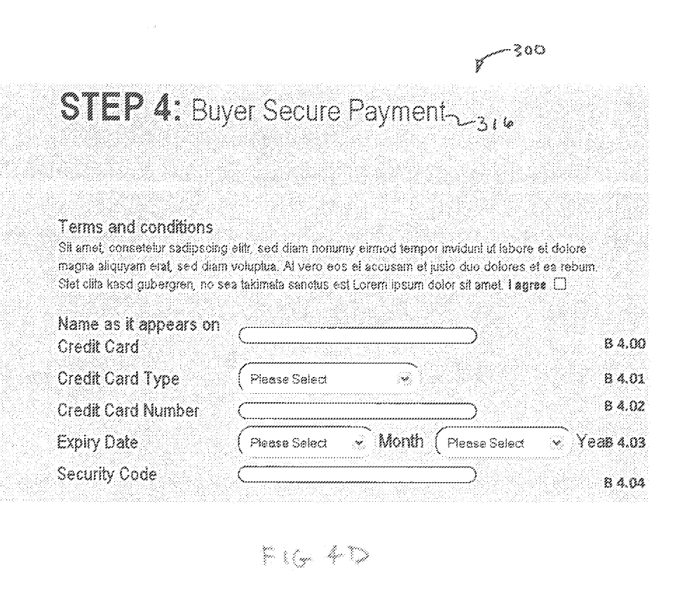

FIGS. 4A-4D depict buyer registration screens, generally designated 300, in accordance with one embodiment. In at least one or more embodiments, buyer registration comprises entering information into the screens 300 using the user interface devices in one or more steps or stages. In at least one embodiment, Step 1, illustrated in FIG. 4A and designated 310, enables the buyer to enter personal information including name, address, email address, username, password, and general information regarding buying the business. Step 2 depicted in FIG. 4B and generally designated 312, enables the buyer to enter financial information including assets, liabilities and additional information.

FIG. 4C depicts Step 3, generally designated 314, enables the buyer to enter business management experience, including number of years in business, industry experience, education level and the like. In at least one embodiment, FIG. 4D illustrates Step 4, generally designated 316, which enables the buyer to enter payment information, including credit card information.

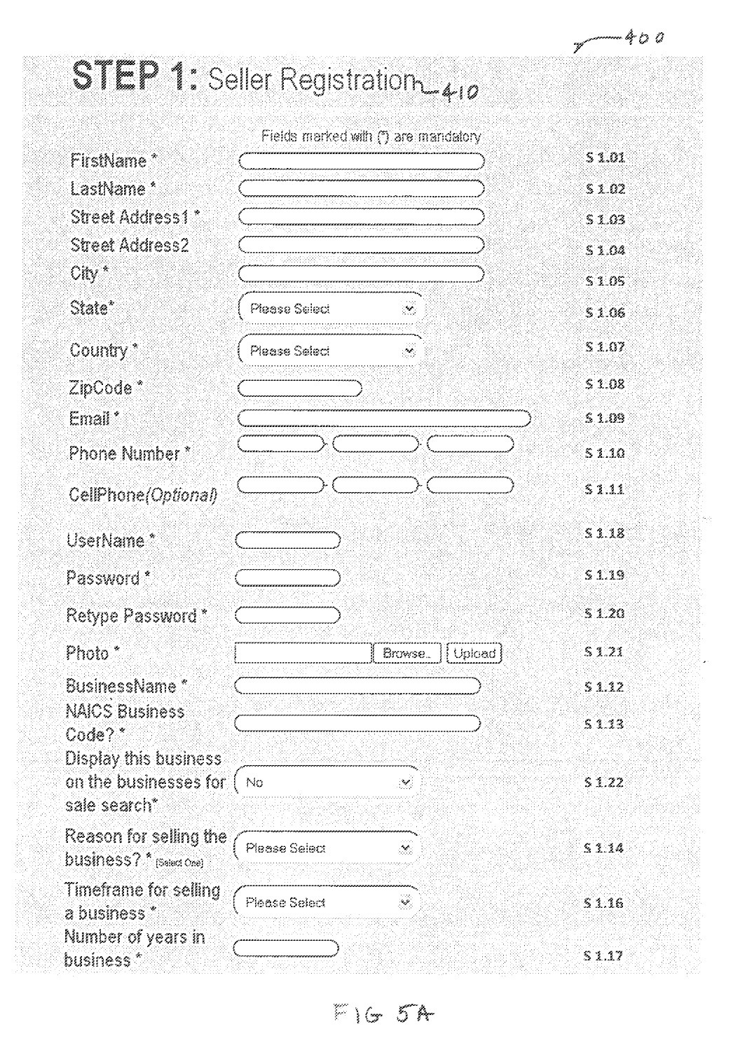

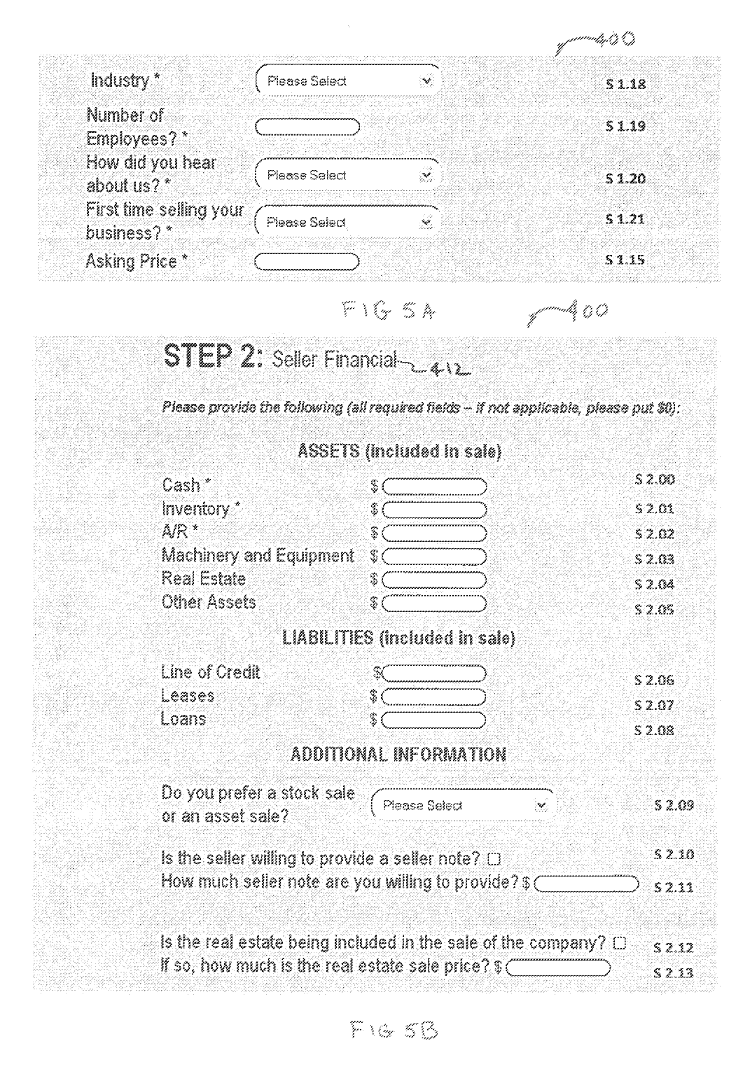

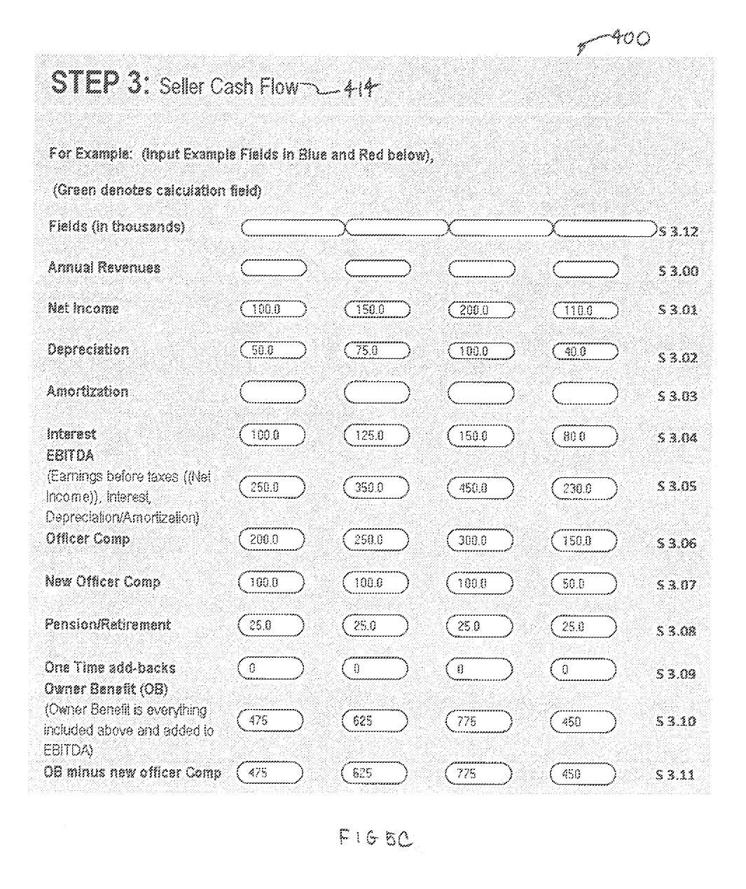

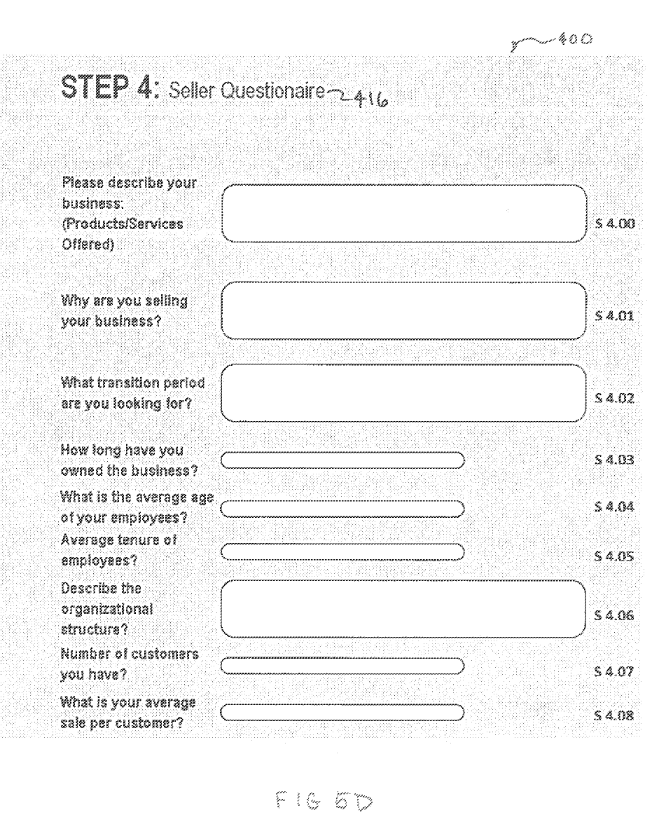

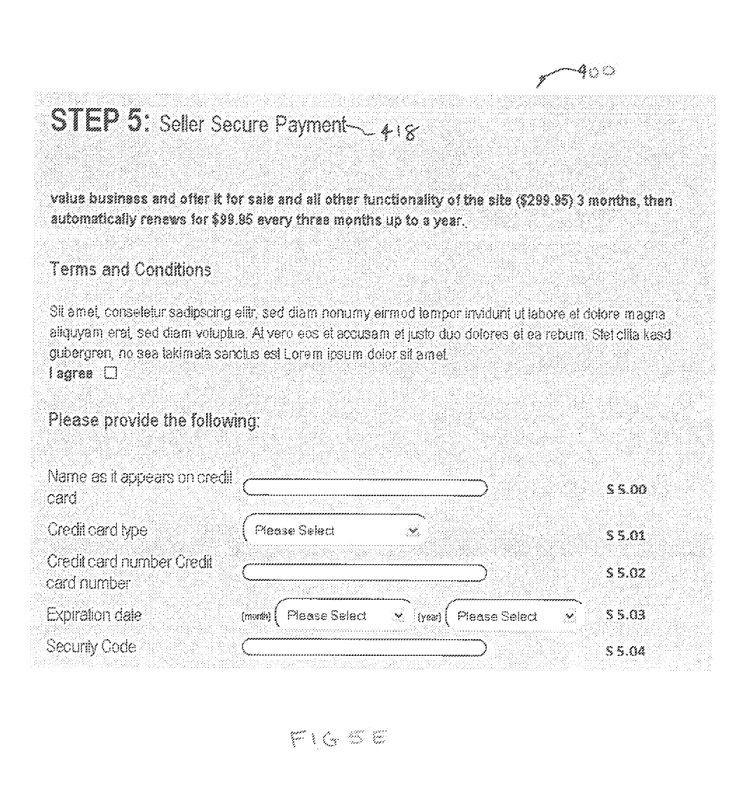

FIGS. 5A-5E depict seller registration screens, generally designated 400, in accordance with one embodiment. In at least one or more embodiments, seller registration comprises entering information into the screens 400 using the user interface devices in one or more steps or stages. In at least one embodiment, Step 1, illustrated in FIG. 5A and designated 410, enables the seller to enter personal information including name, address, email address, username, password; in addition to business information including business name, reason for selling, timeframe and number of years in business. Step 2 depicted in FIG. 5B and generally designated 412, enables the seller to enter financial information including assets, liabilities and additional information. FIG. 5C depicts Step 3, generally designated 414, and enables the seller to enter business management experience, including annual revenues, net income, depreciation, amortization, interest, new officer compensation, one time add-backs, owner benefits and owner benefits minus new officer compensation. FIG. 5D depicts Step 4, generally designated 416 which includes a seller questionnaire enabling the seller to input information describing the business, reason for selling the business transition period, average age and tenure of employees, organizational structure, number of customers and average sale per customer. In at least one embodiment, FIG. 5E illustrates Step 5, generally designated 418, enables the seller to enter payment information, including credit card information.

In at least one embodiment, the buyer side qualification and filtering engine 104 used to determine a qualifying score for at least one buyer includes determining the one or more buyer's portion of TomScore. Determining the buyer's portion of TomScore includes using one or more of the following calculation methods: Buyer Character Calculation; Buyer Management Calculation; BuyerCashFlow Calculation; and/or the BuyerCollateral Calculation.

In at least one embodiment, determining the one or more buyer's portion of TomScore includes performing a BuyerCharacter Calculation, which calculates the character of a buyer. Information is retrieved from the information entered using the registration screens 300/400 and stored in the database and includes, for example: Date of Birth; Education; FICO; and Bankruptcy information.

In yet one more embodiments determining a qualifying score includes performing a buyer management calculation where information is retrieved from the information entered using the screens 300/400 and stored in the database. The information includes for example: Number of Years in Business; Years Owning a Business; Years in an Industry; and Compensation.

In at least one embodiment, the buyer side qualification and filtering engine 104 may determine the qualifying score by performing abuyercashflow calculation where information is retrieved from the database and includes for example: Living HouseHold Expenses; and Outside Income.

In at least one embodiment, the buyer side qualification and filtering engine 104 may be used to determine the qualifying score which includes determining buyercolleratal calculation where information is retrieved from the information entered using the screens 300/400 and stored in the database and includes for example: Cash; Stocks and Bonds; Life Insurance; and Real Estate Value.

In one or more embodiments, one, two, three or all four methods are used to constitute the calculation of buyer's portion of Tom Score.

In at least one embodiment, the seller side qualification and filtering engine 154 determines a qualifying score for at least one seller, includes determining the one or more seller's portion of the TomScore Calculations. Determining the seller's portion of the TomScore calculation includes using one or more of the following methods: WeightedAverageEarnings Calculation; BizValueAdjusted Earnings Calculation; BizValue weighedAverage Calculation; BizValue; BizAssets; and/or UpdateBizValue.

In at least one embodiment, the seller side qualification and filtering engine 154 determines the qualifying score includes performing a weightedAverageEarnings Calculation where information is retrieved from the information entered using the screens 300/400 and stored in the database and includes calculating and returning one or more weighted average of a seller's business, comprising for example: income; depreciation; amortization; interest; Officer Compensation; new officer compensation; pension; and one time add backs of the seller for one or more years.

In at least one embodiment, determining the one or more seller's portion of the TomScore calculation includes performing a BizValueAdjustedEarnings Calculation where information is retrieved from the information entered using the screens 300/400 and stored in the database.

In at least one embodiment, determining the one or more seller's portion of the TomScore calculation includes performing a BizValueWeightedCalculation where information is retrieved from the information entered using the screens 300/400 and stored in the database and includes for example: Earnings; Discounts; Growth; and NPV.

In at least one embodiment, determining the one or more seller's portion of the TomScore calculation includes performing a BizValue where information is retrieved from the information entered using the screens 300/400 and stored in the database and includes values returned by adding BizValueWeightedAverage Calculation and BizValueAdjustedEarnings Calculation.

In at least one embodiment, determining the one or more seller's portion of the TomScore calculation includes performing a BizAssets where information is retrieved from the information entered using the screens 300/400 and stored in the database and includes values based on the cash; inventory; A/R; Equipment; Real Estate; Other Assets; Line of credit; leases; and loans.

In at least one embodiment, determining the one or more seller's portion of the TomScore calculation includes performing UpdateBizValues where information is retrieved from the information entered using the screens 300/400 and stored in the database and includes Goodwill for example.

In at least one embodiment, an overall score comprised of the qualifying score of the buyers and the qualifying score of the sellers is determined by the matching engine 130, alternatively referred to as TomScore. In at least one embodiment, the overall score or TomScore is based a specified point system, 400 points for example. A TomScore is arrived at when at least one buyer and seller are compared against one another, where the possible total points for the TomScore include, for example, a buyer character score; buyer management score; collateral and cash flow.

While embodiments of the invention relate to selling a business, other embodiments are contemplated including any financial transaction or exchange in any number of industries including for example, lending, investment properties, real estate, insurance. Medallion financing or anything scoring with subjective and objective variables in order to make a deal happen and then directly link them to the strategic partners needed in order to get the deal finished and completed.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is intended that they be deemed within the scope of this invention.

We claim:

1. A method for enabling selling a business, the method comprising:
forming a set of qualified buyers and a set of qualified sellers;
enabling only the set of qualified buyers to view at least one business offered for sale by the set of qualified sellers;
enabling the set of qualified buyers and the set of qualified sellers to upload documents necessary to fund and close the sale of the at least one business; and
providing the set of qualified buyers and the set of qualified sellers access to trusted support professionals.

2. The method of claim 1 wherein determining a set of qualified sellers comprises determining a qualifying score for at least one seller based on at least one subjective and objective criteria.

3. The method of claim 2 wherein the at least one subjective and objective criteria for determining a qualifying score for at least one seller is selected from the group comprising WeightedAverageEarnings Calculation: BizValueAdjusted Earnings Calculation; BizValueWeighedAverage Calculation; BizValue; BizAssets; and UpdateBizValue.

4. The method of claim 2 wherein determining a set of qualified buyers comprises determining a qualifying score for at least one buyer based on at least one subjective and objective criteria.

5. The method of claim 4 wherein the at least one subjective and objective criteria for determining a qualifying score for at least one buyer is selected from the group comprising Buyer Character Calculation; Buyer Management Calculation; BuyerCashFlow Calculation; and Buyer Collateral Calculation.

6. The method of claim 4 further comprising deriving an overall score based at least in part on the qualifying score of the at least one seller and the qualifying score for the at least one buyer.

7. The method of claim 6 wherein forming the set of qualified buyers and the set of qualified sellers further comprises matching at least one buyer with at least one seller based on the derived overall score.

8. The method of claim 1 wherein the trusted support professions is selected from the group comprising brokers, attorneys, accountants, financial advisors, insurance representatives and bank representatives

9. A system for computer moderated selling of a business, the system comprising:
a matching engine configured to forming a set of qualified buyers and a set of qualified sellers; and
a server having instructions operating thereon enabling only the set of qualified buyers to view businesses offered for sale by the qualified sellers; enabling the set of qualified buyers and the set of qualified sellers to upload documents necessary to fund and close the sale of the at least one business; and provide the set of qualified buyers and the set of qualified sellers access to trusted support professionals.

10. The system of claim 9 wherein the match engine is further configured to determine a qualifying score for a plurality of sellers based on at least one subjective and objective criteria.

11. The system of claim 10 wherein the match engine is further configured to determine a qualifying score for a plurality of buyers based on at least one subjective and objective criteria.

12. The system of claim 11 wherein the at least one subjective and objective criteria for determining a qualifying score for at least one seller is selected from the group comprising WeightedAverageEarnings Calculation: BizValueAdjusted Earnings Calculation; BizValueWeighedAverage Calculation; BizValue; BizAssets; and UpdateBizValue; and the at least one subjective and objective criteria for determining a qualifying score for at least one buyer is selected from the group comprising Buyer Character Calculation; Buyer Management Calculation; BuyerCashFlow Calculation; and Buyer Collateral Calculation.

13. The system of claim 11 wherein the match engine is further configured to determine a match between a plurality of buyers with at least one seller based on a derived overall score comprised of the qualifying score of the plurality of buyers and the qualifying score of the plurality of sellers, thereby forming the set of qualified buyers and the set of qualified sellers.

14. A computer program comprising:
a computer readable medium having computer readable instructions for selling a business, the computer readable instructions configured to:
forming a set of qualified buyers and a set of qualified sellers;
enabling only the set of qualified buyers to view at least one business offered for sale by the set of qualified sellers;
enabling the set of qualified buyers and the set of qualified sellers to upload documents necessary to fund and close the sale of the at least one business; and
providing the set of qualified buyers and the set of qualified sellers access to trusted support professionals.

15. The program of claim 14 wherein determining a set of qualified sellers comprises determining a qualifying score for at least one seller based on at least one subjective and objective criteria.

16. The program of claim 15 wherein determining a set of qualified buyers comprises determining a qualifying score for at least one buyer based on at least one subjective and objective criteria.

17. The program of claim 16 wherein the at least one subjective and objective criteria for determining a qualifying score for at least one seller is selected from the group comprising WeightedAverageEarnings Calculation: BizValueAdjusted Earnings Calculation; BizValueWeighedAverage Calculation; BizValue; BizAssets; and UpdateBizValue; and the at least one subjective and objective criteria for determining a qualifying score for at least one buyer is selected from the group comprising Buyer Character Calculation; Buyer Management Calculation; BuyerCashFlow Calculation; and Buyer Collateral Calculation.

18. The program of claim 16 further comprising deriving an overall score based at least in part on the qualifying score of the at least one seller and the qualifying score for the at least one buyer

19. The program of claim 18 wherein forming the set of qualified buyers and the set of qualified sellers further comprises matching at least one buyer with at least one seller based on the derived overall score.
